(19) United States
(12) Patent Application Publication
(10) Pub. No.: US 2016/0365931 A1
(43) Pub. Date: Dec. 15, 2016

(54) REMOTE NODE CONFIGURATION FOR PROVIDING UPGRADED SERVICES IN A PASSIVE OPTICAL NETWORK AND A PASSIVE OPTICAL NETWORK HAVING THE SAME

(71) Applicant: KOREA ADVANCED INSTITUTE OF SCIENCE AND TECHNOLOGY, YUSEONG-GU (KR)

(72) Inventors: Chang-Hee LEE, Yuseong-gu (KR); Jong-Hoon LEE, Dong-gu (KR); Ki-Man CHOI, Dong-gu (KR); Sil-Gu MUN, Buk-gu (KR); Jung-Hyung MOON, Sasang-gu (KR); Hoon-Keun LEE, Kyungsan-si (KR)

(73) Assignee: KOREA ADVANCED INSTITUTE OF SCIENCE AND TECHNOLOGY, YUSEONG-GU (KR)

(21) Appl. No.: 14/134,896

(22) Filed: Dec. 19, 2013

Related U.S. Application Data
(63) Continuation of application No. 12/681,551, filed on Jul. 20, 2010, now abandoned.

(30) Foreign Application Priority Data
Oct. 5, 2007 (KR) 10-2007-0100553

(51) Int. Cl. H04B 10/80; H04J 14/02; H04Q 11/00; H04B 10/272

(52) U.S. Cl. CPC H04B 10/807; H04B 10/272; H04J 14/0282; H04Q 11/0067; H04Q 11/0005; H04Q 2011/0069; H04Q 2011/0081; H04Q 2011/0009; H04Q 2011/0015

(57) ABSTRACT

In an RN configuration for providing a new service in a PON, it is possible to configure the RN remotely by instantaneous powering from a remote site only when necessary, while the RN being operated as a PON at ordinary times. More specifically, an RN configuration for providing a new service in a PON according to the present invention includes a power generation block capable of providing energy necessary for activating the RN by instantaneously supplied power from the remote site. Further, an RN according to the present invention further includes either one or both of a control agent block capable of controlling and managing optical paths of the RN by using power generated from the power generation block; and a reconfigurable switching block capable of configuring and switching the optical path of the RN through the power being provided from the power generation block and a control by the control agent block.

### CROSS-REFERENCE TO RELATED APPLICATIONS

This application is a Continuing Application of U.S. application Ser. No. 12/681,551, filed on 20 Jul. 2010, which is a National Stage Application of PCT/KR2007/004959, filed on 10 Oct. 2007, which claims benefit of Application No. 10-2007-0100553, filed on 5 Oct. 2007 in the Republic of Korea and which applications are incorporated herein by reference. A claim of priority to all, to the extent appropriate, is made.

### TECHNICAL FIELD

The present invention relates to a remote node configuration capable of configuring network environments for providing upgraded services in a passive optical network and a passive optical network having the same. More specifically, the present invention relates to a remote node configuration for efficient evolution and upgrade to provide upgraded services in a network where various services such as service through a time division multiplexing passive optical network (TDM-PON), services through a wavelength division multiplexing passive optical network (WDM-PON), and video overlay services are co-existing or in a network where legacy services and next-generation services are provided together and a passive optical network having the same.

### BACKGROUND

A prior access network using copper wires as a transmission medium is inappropriate for future high-speed access networks due to its loss and a bandwidth limitation of medium itself, which depend on transmission distance. It has been recognized that a Fiber-To-The-Home (FTTH) method, where optical fibers as a transmission medium are installed to the subscribers and information is given and taken therethrough, is considered to be a definite solution for embodying high-speed communication networks that are being developed currently. In the FTTH method, a passive optical network (PON) being comprised of only passive elements between a Central Office (CO) and the subscribers is considered to be the most appropriate method and is most widely used in embodying the FTTH since it has high system stability and minimum usage of optical fiber.

The PON technology is mainly classified as a TDM-PON and a WDM-PON depending largely on a method of sharing an optical fiber and the TDM-PON refers to a PON which shares one optical fiber by using a time division multiple access (TDMA). A commercialization of a TDM-PON has started according to a necessity of FTTH. As specific examples of the TDM-PON, there have been an asynchronous transfer mode (ATM)-PON or a broadband-PON (hereinafter referred to “B-PON”), and an ethernet-PON (hereinafter referred to “E-PON”) having a transmission speed of 1 Gb/s has been commercialized in early 2000 (see K. Ohara, et al., “Traffic analysis of Ethernet-PON in FTTH trial service”, Optical Fiber Comm. Technical Digest, Anaheim, Calif., pp. 607-608, March 2003). After that, a gigabit-PON which transmits signals with a transmission speed of 2.5 Gb/s has been developed and currently reaches at a stage of commercialization.

However, upstream and downstream transmission speeds are fixed to a constant standard speed in the TDM-PON depending on the kinds of PONs and a bandwidth to be provided for each subscriber may be reduced as the number of subscribers is increased (i.e., when increasing a splitting ratio) because a plurality of subscribers commonly uses the TDM-PON. For example, as an average bandwidth provided for each subscriber in a TDM-PON having 32 splitting ratio, an upstream and an downstream transmission speeds are approximately 30 Mb/s, respectively, in case of an E-PON where an upstream and an downstream transmission speeds are approximately 1.25 Gb/s, while an upstream and an downstream transmission speeds are approximately 36 Mb/s and 72 Mb/s, respectively, in case of a G-PON where an upstream and an downstream transmission speeds are approximately 1.25 Gb/s and 2.5 Gb/s, respectively. Further, although a higher speed of the TDM-PON is required as a request for broadband services is sharply increased due to an increase of the use of an internet and generalization of image and video services, there are many technical problems to be solved in order to embody a higher speed of the TDM-PON. Accordingly, a next-generation PON capable of providing higher speed broadband services at lower costs is actively discussed by a standard group such as FSAN (Full Service Access Network) or IEEE.

In the meanwhile, a WDM-PON is referred to a PON which shares one optical fiber by using a wavelength division multiple access (WDMA). Such a WDM-PON has high flexibility and high network expandability, which enables to accommodate various services because it is possible to allocate each signal per each wavelength. Thus, a TDM-PON as a legacy PON is expected to be evolved to a WDM-PON maintaining the wavelength band of the TDM-PON by allocating specific wavelength bands to specific services without wavelength band overlaps, and eventually is expected to be replaced with a WDM-PON having better performance.

The structure and operation of a next-generation PON is developed to a method of accommodating existing legacy-PON services in order to build an effective infrastructure at low costs. As reference materials relating to such prior art, see Korean patent application No. 10-2006-0106159 filed on Oct. 31, 2006, entitled “Apparatus for combining and splitting wavelength bands having three input and output ports,” Korean patent application No. 10-2006-0109293 filed on Nov. 7, 2006, entitled “Method and Network Architecture for Upgrading Legacy Passive Optical Network to Time Division Multiplexing Passive Optical Network Based Next-Generation Passive Optical Network,” and Korean patent application No. 10-2006-0109544 filed on Nov. 7, 2006, entitled “Method and Network Architecture for Upgrading Legacy Passive Optical Network to Wavelength Division Multiplexing Passive Optical Network Based Next-Generation Passive Optical Network,” etc. In addition, as relating to research treatises such prior art as describe above, see Ki-Man Choi, et al., “Evolution Method of legacy TDM-PON to NGA-PON,” Photonics Conference 2006, TP42 and Ki-Man Choi, et al., “An Efficient Evolution Method for Legacy TDM-PON to Next-Generation PON,” IEEE Photonics Technology Letters, vol. 19, no. 9, pp. 647-649, 2007, etc.

In prior art described above, some embodiments relating to evolution methods in an existing PON infrastructure (or a legacy PON infrastructure) are disclosed, and various methods for reconfiguring a network where existing services and new services are accommodated together and various methods for providing new services to existing subscribers (or legacy subscribers) by substituting passive elements and reconfiguring connections, etc., are suggested together therein. That is, for reconfiguring of an optical path necessary for providing upgraded services, methods may be used where elements including wavelength band splitting filters and MUX/DEMUXs, etc. are newly installed at the CO and the RN (installed when a legacy PON was deployed) or reconnection of optical paths for new services is newly made.

During evolutions and upgrades through the above suggested methods, all requirements for the above process are not satisfied with only one installation. In addition, these requirements occur continuously upon the request of legacy subscribers or internet service providers (ISPs). Furthermore, such processes of evolutions and upgrades are not able to satisfy all the cases by only one method, and various methodological approaches are available depending on the circumstances. Ultimately, all or some services will be substituted by next-generation services having better performance and thus any effective methods for this purpose are required.

An access network must accommodate all the current and future requirements and be constructed effectively. A prior PON can reduce deployment costs and operation/ maintenance costs with high system stability and minimum usage of optical fibers since it is comprised of only passive elements between the CO and the subscribers. However, such a prior PON system is comprised of only passive elements and thus there is no possibility for reconfiguring a network environment dynamically in any method. Reconfiguration of an optical path by field installations or substitutions on the spot for evolution and upgrade is required in such an access network. However, as the RN is mostly located outside and field installations or substitutions are required upon each new request of evolution and/or upgrade, it is not preferable when considering the costs, and management and operations thereof.

That is, there are various disadvantages in constructing and managing an access network for the changes of access circumstances such as evolution and upgrade, etc. to a future next-generation network in a current PON concept or configuration. Therefore, a new method for providing enhanced services effectively and adapting to the access circumstances, while maintaining the advantages of a prior PON as they are, is required.

### SUMMARY

The object of the present invention is to solve the prior art problems and to provide an RN configuration where the RN is configured remotely with a remote control at a remote site so as to provide enhanced services and is activated by power supplied from the outside only when necessary, and a PON having the same.

More specifically, the present invention is to provide an RN configuration capable of configuring a network environment for providing enhanced services by instantaneously supplied power only when necessary, while being operated as a PON at ordinary times, and a PON having the same. Herein, a typical example of configuring a network environment is configuring an optical path.

A specific example of configuring an optical path includes new connections for providing enhanced services such as configuring various services using different wavelength bands allocation (typically services being provided by using a TDM-PON, services being provided by using a WDM-PON, and video overlay services), configuring MUX/DEMUXs, and configuring optical fiber connections, etc.

Further, the present invention is to provide an RN configuration capable of configuring and managing a network where control and power are supplied remotely and instantaneously rather than continuously, and it is able to provide a network configuration and management adapting for the rapid changes of access circumstances through a remote control, while maintaining the advantages of a PON such as stability and reliability.

A desirable method in configuring and managing an RN having the features described above (i.e., capable of configuring a network through a remote control while maintaining the advantages of a PON such as stability and reliability) may be embodied by using elements having a latching characteristic. Especially, it is able to configure an optical path of an RN by instantaneous powering and using a switch having a latching characteristic (hereinafter referred to “a latching switch”), and thereafter maintain elements at the RN in a passive state except at the moment of configuring an optical path of the RN.

In addition, another desirable method in configuring and managing an RN having the features described above (i.e., capable of configuring a network through a remote control while maintaining the advantages of a PON such as stability and reliability) may be embodied by optical powering through an optical fiber at CO or a remote site and converting optical power into electrical power, and then the converted electrical power is used in configuring and managing the RN.

An RN configuration according to the present invention comprises a power generation block for being provided energy instantaneously from the outside and providing energy necessary for operation of the RN, a control agent block for selecting a specific optical path of the RN and controlling the specific optical path by using power generated from the power generation block, a reconfigurable switching block for configuring the optical path of the RN through the power being provided from the power generation block and the control by the control agent block.

According to a first aspect of the present invention, the present invention is to provide a remote node (RN) configuration for providing a new service in a passive optical network (PON), wherein the RN is operated as a PON at ordinary times, while the RN is able to configure a network environment which provides an enhanced service by instantaneously powering from a remote site only when necessary.

According to a second aspect of the present invention, the present invention is to provide a remote node (RN) configuration for providing a new service in a passive optical network (PON), wherein the RN includes a power generation block capable of providing energy necessary for operation of the RN by being provided instantaneously from a remote site.

According to a third aspect of the present invention, the present invention is to provide a remote node (RN) configuration for providing a new service in a passive optical network (PON), wherein the RN comprising: an optical splitter (splitter 1) having a plurality of first output ports for transmitting one specific service to a plurality of first group distribution fibers; a second wavelength band combiner/splitter (WBCS), being provided at a front end of the optical splitter (splitter 1), for providing the optical splitter (splitter 1) with the one specific service; a MUX/DEMUX, being connected to the second WBCS, having a plurality of second output ports for transmitting the new service to the plurality of first group distribution fibers capable of providing the new service; and a plurality of first switches, being placed between the plurality of first output ports and the plurality of first group distribution fibers and being connected to the plurality of second output ports, for configuring a switched service to be connected to the plurality of first group distribution fibers.

According to a fourth aspect of the present invention, the present invention is to provide a remote node (RN) configuration for providing a new service in a passive optical network (PON), wherein the RN comprises a reconfigurable switching block having a band block for switching a specific band of one service to a specific band of another service, and wherein the band block comprises: a wavelength band combiner/splitter (#1), being embodied by a first edge filter, a second edge filter being connected to the first edge filter, and one CWDM filter being connected to the first edge filter, for providing a legacy service; a service selector/splitter comprising a switching block (BB) being connected to the one CWDM filter, and a first band selection and combination filter (#2), being connected to the switching block (BB), for selecting and splitting a specific band (λ3) from the legacy service; and a second band selection and combination filter (#3), being connected respectively to the first band selection and combination filter (#2), the one CWDM filter, and the second edge filter, for connecting the specific band (λ3) split by the first band selection and combination filter (#2) to the second edge filter.

According to a fifth aspect of the present invention, the present invention is to provide a remote node (RN) configuration for providing a new service in a passive optical network (PON), wherein the RN comprises a reconfigurable switching block having a band block for switching a specific band of one service to a specific band of another service, wherein the band block is embodied by a wavelength band combiner/splitter (#1), and wherein the wavelength band combiner/splitter (#1) comprises: a first CWDM filter for providing a legacy service and a second CWDM being connected to the first CWDM filter; a service selector/splitter comprising a first switch being connected to the first CWDM filter, and a first band selection and combination filter (#2), being connected to the first switch, for selecting and splitting a specific band (λ2) from the legacy service; a second band selection and combination filter (#3), being connected to the first switch, for selecting and splitting some band (λ3) from the specific band (λ2); and a second switch, being connected respectively to the first band selection and combination filter (#2), the second band selection and combination filter (#3), and the second CWDM filter, for connecting either the specific band (λ2) split by the first band selection and combination filter (#2) or the some band (λ3) split by the second band selection and combination filter (#3) selectively to the second CWDM filter.

According to a sixth aspect of the present invention, the present invention is to provide a remote node (RN) configuration for providing a new service in a passive optical network (PON), wherein the RN comprising: an optical splitter (splitter 1) having a plurality of first output ports for transmitting an existing first service to a plurality of first group distribution fibers; a MUX/DEMUX having a plurality of second output ports for outputting an existing second service, which is not superimposed with the existing first service, to a plurality of second group distribution fibers, and a plurality of third reserved ports for outputting a specific band, which is split from either one of the existing first service or the existing second service, to the plurality of first group distribution fibers; and a plurality of switches, being placed between the plurality of first output ports and the plurality of first group distribution fibers and being connected to the plurality of third reserved ports, for switching the specific band to be connected to the plurality of first group distribution fibers, and wherein the existing first service and the specific band are being provided selectively to the plurality of first group distribution fibers by the plurality of switches.

According to a seventh aspect of the present invention, the present invention is to provide a remote node (RN) configuration for providing a new service in a passive optical network (PON), wherein, when a fault occurs on an optical path which is being operated, the RN is capable of reconfiguring the optical path where the fault occurs to a reserved optical path by instantaneously powering from a remote site.

According to an eighth aspect of the present invention, the present invention is to provide a remote node (RN) configuration for providing a new service in a passive optical network (PON), wherein the RN comprises: a third wavelength band combiner/splitter for splitting a communication signal band being provided through an optical fiber from a remote site and an optical trigger signal, which is not used in the communication signal band and is provided selectively; a power generation block, being connected to the third wavelength band combiner/splitter, for generating first power from the optical trigger signal extracted by the third wavelength band combiner/splitter; a switch, being connected to the third wavelength band combiner/splitter and the power generation block, respectively, for switching from a bar state to a cross state or vice versa by being provided with the first power generated from the power generation block; a control agent block, being connected to the switch, for controlling a reconfiguration of an optical path of the RN and a communication between the RN and the remote site by using some signal band of the communication transmitted through the third wavelength band combiner/splitter when the switch is in the cross state; a fourth wavelength band combiner/splitter, being provided between the switch and the control agent block, for splitting the some signal band of the communication signal band transmitted through the third wavelength band combiner/splitter when the switch is in the cross state and connecting the split some signal band to the control agent block, and for connecting signals other than the split some signal band among the communication signal band to the power generation block so as to generate second power necessary for activating the RN; and a reconfigurable switching block, being connected to the switch, for reconfiguring the optical path of the RN by using the second power being provided from the power generation block and a control signal being provided from the control agent block when the switch is in the bar state.

According to a ninth aspect of the present invention, the present invention is to provide a passive optical network (PON) comprising: a central office (CO); a remote node (RN) being connected to the CO through an optical fiber; and a plurality of ONTs being connected to the RN by distribution fibers, wherein the RN comprises: a third wavelength band combiner/splitter for transmitting a communication signal band being provided from the CO or the plurality of ONTs and an optical powering signal for generating power, which is not used in the communication signal band and is provided selectively; a fourth wavelength band combiner/splitter, being connected to the third wavelength band combiner/splitter, for splitting the a communication signal band and the optical powering signal for generating power; a power generation block, being connected to the fourth wavelength band combiner/splitter, for generating power necessary for activating the RN from the optical powering signal for generating power extracted by the third wavelength band combiner/splitter; a control agent block, being connected to the fourth wavelength band combiner/splitter, for controlling a reconfiguration of an optical path of the RN and a communication between the RN and the CO or between the plurality of ONTs by using the power generated by the power generation block; and a reconfigurable switching block, being connected to the third wavelength band combiner/splitter, for reconfiguring the optical path of the RN by using the power being provided from the power generation block and a control signal being provided from the control agent block.

According to a tenth aspect of the present invention, the present invention is to provide an active optical network (AON) comprising: a central office (CO); a remote node (RN) being connected to the CO through an optical fiber; and a plurality of ONTs being connected to the RN by distribution fibers, wherein the RN comprises: a third wavelength band combiner/splitter for transmitting a communication signal band being provided from the CO or the plurality of ONTs and an optical powering signal for generating power, which is not used in the communication signal band and is provided selectively; a fourth wavelength band combiner/splitter, being connected to the third wavelength band combiner/splitter, for splitting the communication signal band and the optical powering signal for generating power; a power generation block, being connected to the third wavelength band combiner/splitter, for generating power necessary for activating the RN from the optical powering signal for generating power extracted by the third wavelength band combiner/splitter; a control agent block, being connected to the fourth wavelength band combiner/splitter, for controlling a reconfiguration of an optical path of the RN and a communication between the RN and the CO or between the plurality of ONTs by using the power generated by the power generation block; and a reconfigurable switching block, being connected to the third wavelength band combiner/splitter, for reconfiguring the optical path of the RN by using the power being provided from the power generation block and a control signal being provided from the control agent block.

Further features and advantages of the present invention can be obviously understood with reference to the accompanying drawings where same or similar reference numerals indicate same components.

A new remote node configuration according to the present invention has the following advantages:

1. It is possible to build an access network capable of being operated effectively and remotely when a legacy PON is evolved and/or upgraded, because an operation method of an RN by instantaneous powering can provide all advantages of a PON such as high reliability and stability, and simultaneously can have all operational advantages of configuring an active network.

2. It is possible to provide better services by switching or managing all or some of specific services to specific subscribers through a remote control and remote reconfiguration of an RN without field works and increase the number of the subscribers.

### BRIEF DESCRIPTION OF THE DRAWINGS

FIG. 1 illustrates a typical configuration of a PON where TDM services, video overlay services, and next-generation services, etc. are co-existing.

FIG. 2 illustrates an embodiment of an RN configuration according to the present invention.

FIG. 3 illustrates an embodiment relating to a configuration of switching an optical path for providing new services according to the present invention.

FIG. 4 illustrates a basic configuration of an apparatus for combining and splitting wavelength bands having three ports for embodying a wavelength band selection device illustrated in an embodiment of an RN configuration of the present invention in FIG. 2.

FIG. 5 illustrates an embodiment of a configuration of an apparatus for combining and splitting wavelength bands having three ports for embodying an embodiment of an RN configuration of the present invention illustrated in FIG. 2.

FIG. 6 illustrates a first embodiment of a wavelength band switching for providing new services at the RN of the present invention illustrated in FIG. 2.

FIG. 7 illustrates a second embodiment of a wavelength band switching for providing new services at the RN of the present invention illustrated in FIG. 2.

FIG. 8 illustrates an embodiment relating to a switching configuration of a MUX/DEMUX depending on a band switching at the RN of the present invention illustrated in FIG. 2.

FIG. 9 illustrates an embodiment of a configuration for switching a connection path to distribution fibers for providing new services at the RN of the present invention illustrated in FIG. 2.

FIG. 10 illustrates an embodiment of methods of reconfiguring a connection to a reserved protection fiber when a fault occurs over a specific optical path of working fibers being operated currently, in the RN configuration and the operation according to the present invention.

FIG. 11 illustrates an embodiment of a configuration of a power generation block at the RN of the present invention.

### DETAILED DESCRIPTION

Hereinafter, structures and functions of preferred embodiments in accordance with the present invention are described in more detail with reference to the appended drawings.

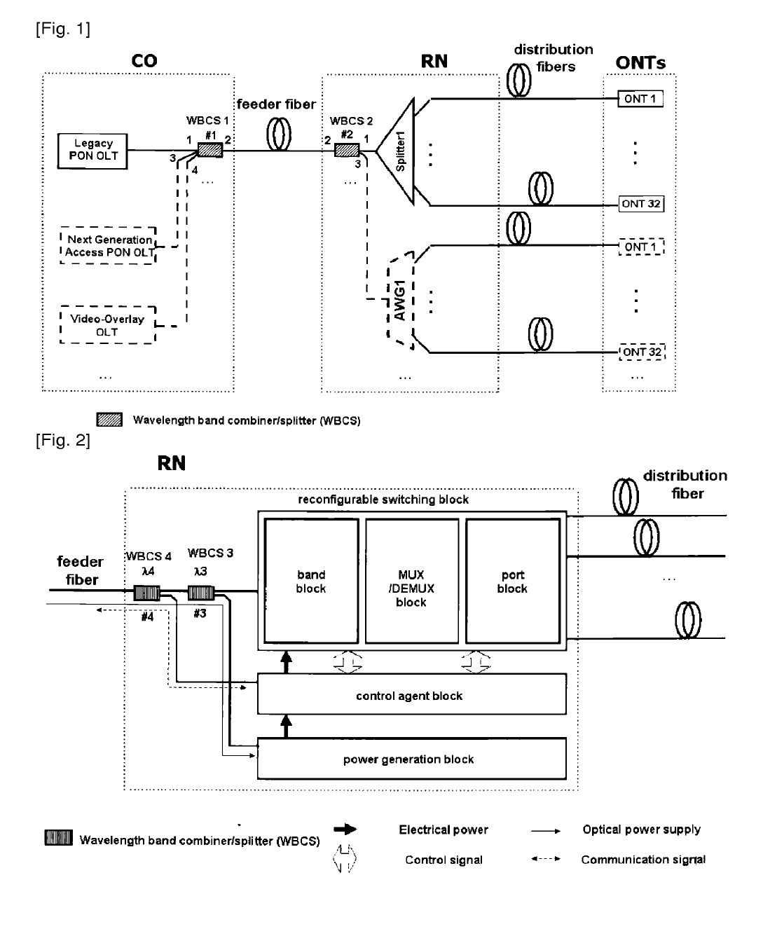

FIG. 1 illustrates a typical configuration of a PON where TDM services, video overlay 2 5 services, and next-generation services, etc. are co-existing.

Referring to FIG. 1, an evolution and an upgrade will be made in a future access network, while various different types of services such as legacy PON services, future WDM-PON services, and video overlay services, etc. which are provided by a legacy PON (for example, TDM-PON) and next generation access PON (hereinafter referred to “NGA-PON”) (for example, WDM-PON), respectively, therein. This network configuration comprises a CO having a plurality of OLTs for providing various types of services; a first wavelength band combiner/splitter (WBCS), being positioned in the CO and connected to the plurality of OLTs, for splitting or combining different services; RN including a plurality of MUX/DEMUX being embodied by a splitter 1 and/or an AWG1, and a second WBCS, being connected to the plurality of MUX/DEMUX, respectively, for splitting or combining the different services; a plurality of ONTs being connected to the plurality of MUX/DEMUX; a feeder fiber being connected between the RN and the CO; and distribution fibers being connected between the RN and the plurality of ONTs.

The first WBCS and the second WBCS illustrated in FIG. 1 may respectively provide three services (hereinafter referred to “a plurality of services”) including a legacy TDM-PON service (legacy OLT), WDM-PON service (NGA-OLT) and video overlay signal through one feeder fiber. In this case, the first WBCS and the second WBCS for combining and splitting a plurality of services have a multiple band transmission characteristic, respectively, and may be embodied by a filter having three or four ports, or a filter having ports corresponding to the number of the plurality of services. A filter having three or four ports may be embodied by various methods. As a more specific example, a filter having three or four ports may be embodied either by integration as a single element having one or more multiple band transmission characteristic based on a thin film filter technology and assembling it based on a micro-optic technology, or by combination of several band selection filters. The band selection filters described above refer to any wavelength band filter having selectivity over any band such as a band pass filter which selects a specific band and an edge filter which passes or stops a band above the specific wavelength, etc.

In a future access network where a TDM-PON service and a WDM-PON service, etc. are co-existing, various evolution and upgrade methods are required in cases of 1) providing a legacy service or a new WDM-PON service while maintaining a legacy TDM-PON service, 2) switching some of services allocated at a specific band to a service allocated at another band and reusing the switched service, 3) adding a new service while various service are co-existing, or 4) providing a new video overlay service while maintaining a TDM-PON service and a WDM-PON service, etc. That is, a reconfiguration and a switching of elements of the system are required for a seamless upgrade of services in order to meet the requirements by a subscriber or an internet service provider (ISP) for a configuration or an operation of an NGA-PON. In other words, various scenarios including a reconfiguration of a legacy PON or reusing bandwidths thereof etc. are required in order to enhance a service performance and increase the number of subscribers.

One example for configuring an NGA-PON which meets the requirements described above is to accommodate two or more services as a whole in one access network by allocating different wavelength bands to a TDM-PON service and a WDM-PON service, respectively, and to perform an operation of adding or switching a new service at a specific upgrade moment.

In addition, various evolution and upgrade methods may be performed in a future access network, upon request of a subscriber or an ISP. A method of additionally providing a TDM-PON service subscriber with a WDM-PON service, a method of switching some or all bands for a specific service to a band for a different service, and a method of additionally providing a new subscriber or a legacy subscriber with a switched new service, etc. may be enumerated as one example of these evolution and upgrade methods.

More specifically, one example of addition or switching a service described above is to switch a video overlay signal band, which is transmitted and overlaid with a TDM-PON service, to a new different service depending on a subscriber's request and to use the switched new service. Another example of addition or switching a service is to switch some of 1300 nm wavelength band or less being used as an upstream signal for a TDM-PON service to be used for a new different service and to reuse the switched wavelength. That is, various requirements for providing a better service by using some or all of a specific bandwidth, which is used in one service, in a specific different service may occur.

However, as described above, all components between a central office (CO) and subscribers are basically comprised of passive elements in a prior art PON configuration. Accordingly, when various requirements in relation to various methods such as a re-configuration of network environments and a reuse of a bandwidth, etc. occur, an evolution and an upgrade of an access network is limited because field reconfiguration on the spot, where a remote node (RN) is located, is required to replace or add some or all components in order to embody such requirements.

FIG. 2 illustrates an embodiment of an RN configuration according to the present invention.

An RN configuration for solving the problems, where an evolution and an upgrade of an access network is limited in a prior art PON configuration, has a feature in embodying a reconfigurable RN including dynamic functions such as a reconfiguration of an optical path and a reuse of a bandwidth, etc. and in driving the RN being provided with power from the outside instantaneously only when a necessity occur. The RN capable of providing an enhanced service being provided with the energy from the outside instantaneously only when a necessity occur, while being operated as a PON at ordinary times, enables to configure and operate an access network which may be adapted to the rapid changes of access environments through a remote control while maintaining advantages of a legacy PON such as stability and reliability.

More specifically, it is desirable to have a reconfigurable switching block capable of switching an optical path of the RN by instantaneous remote powering in order to reconfigure an optical path of the RN such as switching a band, switching a MUX/DEMUX, switching an optical fiber connection, etc., necessary for providing an enhanced service.

In addition, it is desirable to have a power generation block capable of providing energy necessary for the operation of the RN, upon being provided with energy instantaneously from the outside.

Further, it is desirable to have a control agent block capable of configuring the RN capable of controlling an optical path of the RN by using energy generated at the power generation block and providing an enhanced service including communications with the outside, etc.

Referring to FIG. 2, an RN configuration of the present invention includes a power generation block, a control agent block, and a reconfigurable switching block. Such an RN configuration of the present invention operates as a PON at ordinary times, and may be operated for providing enhanced services by being provided instantaneously with the power from the power generation block only when necessary.

Referring back to FIG. 2, an RN, which is operated without constant energy, is embodied in an RN configuration according to the present invention. As described in FIG. 1, an RN located between a feeder fiber and distribution fibers comprises a wavelength band combiner/splitter for splitting a specific service, a WBCS corresponding to the specific service, a MUX/DEMUX corresponding to each service, and distribution fibers for switching connections to subscribers, and further comprises a reconfigurable switching block by including an element capable of controlling an optical path of the RN described above. In this reconfigurable switching block, a specific optical path may be switched selectively only when energy is provided from the outside, and the state of switched path is maintained without energy. That is, it is possible to switch and control an optical path only by instantaneous powering. As a method of switching an optical path by instantaneous powering from the outside, it is possible to generate energy by using optical power being provided through optical fiber, and provide the reconfigurable switching block and the control agent block with the generated energy so as to perform functions such as a switching of signals and bands to a specific band or a specific port, etc. Further the method described above is possible to configure and operate so as to perform functions such as a control, an information exchange, communications, etc., thorough communications with a remote site.

In an embodiment of the present invention illustrated in FIG. 2, optical power is provided to the power generation block through the feeder fiber which is being used for communications. More specifically, an optical powering signal with a wavelength band, which is not used in a signal band for communications,(hereinafter referred to “an optical powering signal for generating power”), is transmitted through the feeder fiber from a remote site such as a CO. The transmitted optical powering signal for generating power is extracted through a third WBCS (λ3) at RN, and the extracted optical powering signal for generating power is provided to the power generation block and is converted into electric energy. In case of FIG. 2, although it is described that optical power is provided from the CO to the power generation block at the RN by using an optical powering signal having a downstream wavelength band which is not used for the communication signal band, Any skilled person in the art may fully understand that it is possible to generate electric energy by providing the power generation block at the RN with an optical powering signal through an optical fiber using a wavelength band which is not used for the communication signal band, from a remote site such as subscriber sides or from other remote sites.

Further, the control agent block of the present invention illustrated in FIG. 2 is a device capable of performing some or all of various functions relating to an operation of the RN. Those functions of the control agent block include a function of controlling the RN; a function of the RN for communicating with the outside; and a function of collecting various information including the status information of the RN or other information relating to operations of a network, and information about external environments other than the operations of a network, etc., recording such various information, and reporting the various information upon necessity. More specifically, the control agent block may control a switching of various network paths including reconfiguring a path, switching and reusing a band, or connecting a specific signal to a specific output of optical fibers, etc. In addition, the control agent block may perform network managements effectively, by examining or recording results of the control described above and by reporting and receiving various information through a communication with the outside. The communication with the outside described above is possible to communicate with a CO or a remote site through a fourth WBCS (λ4).

In the meanwhile, the reconfigurable switching block of the present invention illustrated in FIG. 2 is an apparatus capable of switching of an optical path for reconfiguring a band, a path and a port, etc. of the RN, a switching of a reserved band or a switching of a service, and a switching of a port, etc. The reconfigurable switching block may have a function of reconfiguring an optical path in a pre-determined manner depending on various operation scenarios or depending on any remote control. In addition, the reconfigurable switching block may include some or all of at least a band block, a MUX/DEMUX block, and a port block.

Further, an embodiment of the present invention illustrated in FIG. 2 may additionally have a plurality of WBCSs for splitting and switching different services and is possible to activate the RN of the present invention effectively.

Although an RN configuration according to an embodiment of the invention illustrated in FIG. 2 is described to include the power generation block, the control agent block, and the reconfigurable switching block, which is illustrative, the RN configuration may be configured to include only some of the power generation block, the control agent block, and the reconfigurable switching block. For example, in case of RN which requires only one band switching, it is possible to switch a path of RN depending on a pre-determined control by being provided with necessary energy required for switching the path from a remote site, without a separate control agent block or a control signal. As another example, in case of monitoring the configuration information (or switched information) of the RN or status information of a network, it is possible to collect the switched information of the RN and the status information of a network only through a communication with the RN, even without any operations of the reconfigurable switching block.

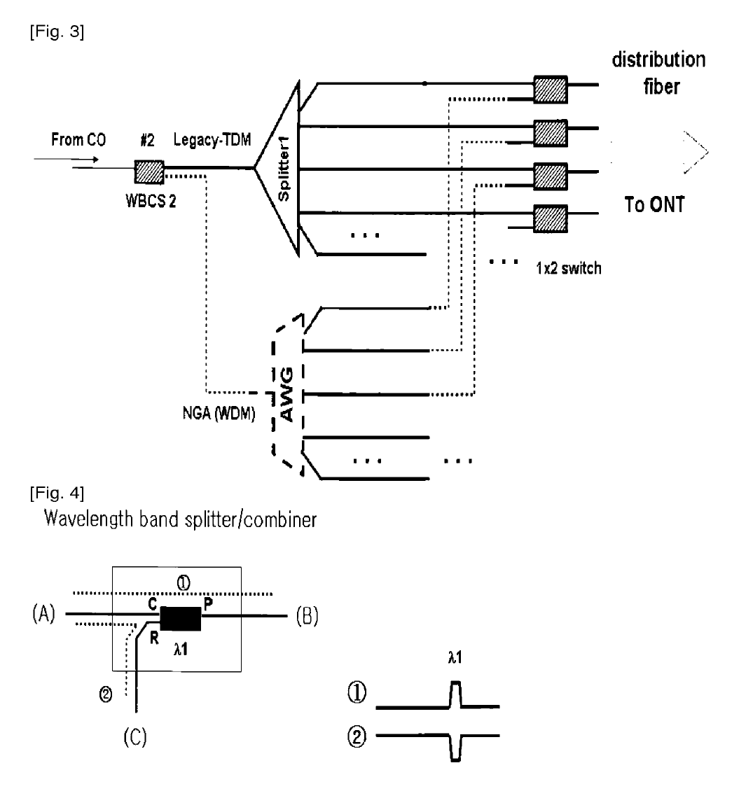

An embodiment of the invention illustrated in FIG. 2 describes to include the power generation block, the control agent block, and the reconfigurable switching block, as illustrative, and some or all of the power generation block, the control agent block, and the reconfigurable switching block are possible to be configured to have a function of a path switching. That is, a band block, a MUX/DEMUX block, and a port block, which are components of the reconfigurable switching block for controlling an optical path of the RN, have a feature in that they may provide the switchable and non-switchable optical path.. For example, in case that a switching to a specific service is required for subscribers, the RN may be configured to meet the requirement above by configuring the reconfigurable switching block which is comprised of passive elements which do not have a switchable optical path such as the MUX/DEMUX block comprising a MUX/DEMUX corresponding to a specific service, and the band block comprising a WBCS capable of providing a legacy service and the specific service, while configuring the port block in a manner that it may switch the optical path selectively to distribution fibers and output ports of the MUX/DEMUX. As another example, in case of switching a band being used for a specific service to another service and providing a new subscriber with the switched service, it is possible to meet the requirement above by configuring a band block having a switchable path as the reconfigurable switching block and by configuring the MUX/DEMUX block and the port block in a manner that a corresponding band is switched to the MUX/DEMUX block and an output optical fiber. In this case, the port block and the MUX/DEMUX block provide the switched service depending on a new band switching only for the connection between the input and output ports of the MUX/DEMUX block and the distribution fibers (see FIGS. 3 to 9 which will be described later).

FIG. 3 illustrates an embodiment relating to a configuration of switching an optical path for providing a next generation access (NGA) service (WDM) to legacy TDM service subscribers.

Referring to FIG. 3, a new RN according to an embodiment of the present invention illustrates a configuration of switching an optical path for switching some or all of a specific service (legacy TDM service) to a different service. For this purpose, some or all of the specific service is switched so as to be connected to an output port of a reserved MUX/DEMUX (AWG as a specific example) and to a specific distribution fiber. The new RN according to an embodiment of the present invention illustrated in FIG. 3 is possible to be operated as a PON at ordinary times, maintaining the RN in a passive state, and to switch a specific service to a different service by providing power from a remote site upon request from the outside and by configuring the optical path of the RN.

More specifically, according to an embodiment illustrated in FIG. 3, a specific method is illustrated for embodying an evolution and an upgrade of a TDM-PON service to a WDM-PON service or an evolution and an upgrade of a TDM-PON service to a reserved WDM-PON service in a network where the TDM-PON service and the WTDM-PON service are co-existing.

According to an embodiment illustrated in FIG. 3, it is possible to switch and reconfigure the paths of each subscriber, respectively, through a plurality of first 1×2 switches having a connection between output ports of the AWG providing the WDM-PON service and the distribution fibers where the legacy TDM service is provided. In addition, switching some of the TDM-PON service to the WDM-PON service may be embodied by making some of any band to be provided to the first 1×2 switches using a second WBCS.

A method for managing power effectively in a method of connecting selectively to a plurality of specific distribution fibers by using the plurality of first 1×2 switches may control the plurality of first switches sequentially and thus connect the required paths sequentially. In other words, when the power being provide for the operation of the RN is not sufficient enough, that is, in case that it is difficult to control the plurality of first 1×2 switches all at once according to pre-established control information, it is possible to control the plurality of first 1×2 switches sequentially. The plurality of first 1×2 switches may be embodied to be controllable sequentially depending on the pre-established control information of the control agent block illustrated in FIG. 3.

FIGS. 4 and 5 illustrate a basic operation principle of a WBCS for specific embodiments of a method for configuring and operating the RN of the present invention. A specific embodiment of the WBCS illustrated in FIGS. 4 and 5 may be also used as an embodiment for embodying a method for a band switching of the reconfigurable switching block illustrated in FIG. 2, and is to describe a possible configuration and its application scope of a band block embodied based on the WBCS. More specifically, the WCBS illustrated in FIGS. 4 and 5 may be used as an embodiment of a band block illustrated in FIG. 2 which is configured so as to switch some or all of a specific band for a specific service to a different service and to reuse the switched service. Hereinafter, specific embodiments relating to a configuration of a band block having a WBCS, required for switching to and reusing a specific service and its function will be described.

FIG. 4 illustrates a basic configuration of a WBCS having three ports illustrated in an embodiment of an RN configuration of the present invention in FIGS. 1 to 3.

More specifically, FIG. 4 illustrates a basic configuration of a WBCS having three ports which uses a transmission characteristic and a reflection characteristic of a multi-layer thin film element. In such a WBCS having three ports, a specific band (λ1) from a signal inputted from a port (A) is selected and is outputted to a port (B) (path \textcircled{1}), and a signal having a complementary band of the specific band (λ1) outputted from the port (A) to a port (C) (path \textcircled{2}). The specific band (λ1) may be embodied by a wavelength band pass filter having a band pass characteristic or a wavelength band stop filter having a band stop characteristic, or may be embodied by an edge filter which passes or stops a band above a specific wavelength. In addition, the specific band (λ1) may refer to a whole of a multiple transmission band characteristic which may be embodied by a combination of band filters described above if one multi-layer thin film element having a multiple transmission band characteristic is used. The transmission characteristic between the port (A) and the port (B) (path \textcircled{1}) of the WBCS having three ports described above and the transmission characteristic between the port (A) and the port (C) (path \textcircled{2}) thereof are configured in a complementary manner, and path \textcircled{1} and path \textcircled{2} have the same transmission characteristic even in a case of signals being transmitted in a reverse direction in path \textcircled{1} and path \textcircled{2}, respectively. Respective ports corresponding to the indications (A), (B), and (C), may be indicated as a common port (C port), a pass port (P port), and a reflection port (R port), and, in this case, the specific band (λ1) is determined by a transmission characteristic between the C port and the P port. This WBCS having three ports may split or combine signals having different wavelength bands from or to other signals.

It is possible to configure a WBCS having four ports by connecting another WBCS having three ports to any specific port of the WBCS having three ports in FIG. 4, and may increase the number of the ports depending on the combined or split number of services of a required band. The specific band of the WBCS having three ports above may be recognized as corresponding to a specific service, and therefore the WBCS having three ports described above is obvious to perform a function of splitting and combining a specific service.

FIG. 5 illustrates an embodiment of a configuration of a WBCS having three ports for embodying an embodiment of an RN configuration of the present invention illustrated in FIG. 2.

Referring to FIG. 5, an embodiment for embodying a required band characteristic by combining a first WBCS and a second WBCS having different separate band characteristics (λ1 and λ2), respectively, and a third WBCS for combining the different separate band characteristics (λ1 and λ2) is illustrated. That is, an embodiment in FIG. 5 is embodied by a WBCS having three ports having two band characteristics (λ1 and λ2) simultaneously as a whole, including a first WBCS having a first band characteristic (λ1), a second WBCS having a second band characteristic (λ2), and a third WBCS for combining the first band characteristic (λ1) and the second band characteristic (λ2). More specifically, a WBCS having three ports for designating a first specific band (λ1) and a second specific band (λ2) to one service path (path \textcircled{1} or path \textcircled{2} and for designating their complementary bands to other service path (path \textcircled{3} may be configured by a first WBCS for selecting the first specific band (λ1); a second WBCS for selecting the second specific band (λ2); and a third WBCS for combining the first specific band (λ1) and the second specific band (λ2) to one output. The first specific band (λ1) and the second specific band (λ2) shall not be superimposed to each other. The third WBCS (λ3) may be embodied by the same configuration with either the first WBCS (λ1) or the second WBCS (λ2). Specifically, the third WBCS may be embodied by any WBCS for combining the first specific band (λ1) and the second specific band (λ2) to one output, in a manner that the first specific band (λ1) is selected to be accommodated into path \textcircled{1} and the second specific band (λ2) is selected to be accommodated into path \textcircled{2}.

In an embodiment illustrated in FIG. 5, the first specific band (λ1) is selected from signals inputted from the port (A) is selected and is outputted to the port (B) via path port \textcircled{1} and the second specific band (λ2) is outputted from the port (A) to the port (B) via path \textcircled{2}. Respective complementary signal bands of the first specific band (λ1) and the second specific band (λ2) is outputted from the port (A) to the port (C) via path \textcircled{3}. The first WBCS and the second WBCS described above may be respectively embodied by a wavelength band pass filter having a band pass characteristic or a wavelength band stop filter having a band stop characteristic, or may be embodied by an edge filter which passes or stops only a band above a specific wavelength. Moreover, the first WBCS and the second WBCS described above may be respectively embodied by using one multi-layer thin film element having multiple band characteristics. In the WBCS having three ports in FIG. 5 described above, the transmission characteristic between the port (A) and the port (B) (path \textcircled{1}+path \textcircled{2}) and the transmission characteristic between the port (A) and the port (C) (path \textcircled{3}) are configured in a complementary manner to each other, and path \textcircled{1} and path \textcircled{2} have the same band characteristic even in a case of signals being transmitted in a reverse direction in path \textcircled{1} and path \textcircled{2}, respectively. Here, the transmission characteristics of port 1 and port 2 of the third WBCS accommodate the transmission characteristic of the first WBCS. In addition, the transmission characteristics of port 2 and port 3 of the third WBCS accommodate the transmission characteristic of the second WBCS. Therefore, the third WBCS either combines the first specific band specific band (λ1) and the second specific band λ2) and outputs the combined band to the port (B), or splits one input inputted from the port (B) to the first specific band specific band (λ1) and the second specific band (λ2). The transmission characteristic between the port (A) and the port (B) is embodied by a sum of any non-superimposed separate transmission characteristics of the first specific band specific band (λ1) and the second specific band (λ2) which are determined through path \textcircled{1} and path \textcircled{2}.

Although the WBCS having three ports described in FIGS. 4 and 5 above is described mainly with elements where a specific band is determined by a transmission characteristic between the C port and the P port, it is obvious that it may use any elements where a specific band is determined by a reflection characteristic between the C port and the P port.

Further, although the first WBCS is illustratively described to be a single element having a band characteristic of the first specific band (λ1) and the second WBCS is illustratively described to be a single element having a band characteristic of the second specific band (λ2) in FIG. 5, any skilled person in the art may fully understand that any WBCS block having three ports comprised of one WBCS having three ports having any band characteristic and a combination of a plurality of such WBCSs may be applied to FIG. 5 in the same manner described above.

The embodiments of an RN configuration of the present invention illustrated in FIGS. 4 and 5 described above are examples capable of configuring only with a minimum number of required wavelength band selection devices, and non-reciprocal elements such as a circulator or isolator (not shown), etc. and/or other filters, etc. for enhancing performance or adding a new function between specific paths may be added separately. Further, a combination of a circulator and a separate filter may be used as an example for embodying the same function as a WBCS. In this case, a configuration of a combination of a circulator and a separate filter on an optical path and an operation characteristic depending on its function have an operation characteristic equivalent to the WBCS having three ports illustrated in FIGS. 4 and 5 described above.

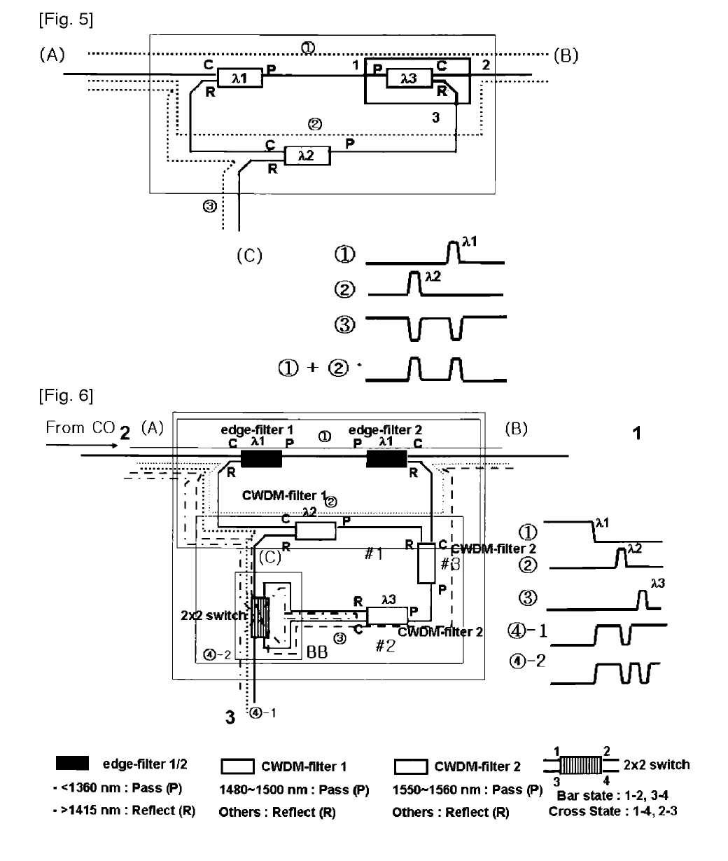

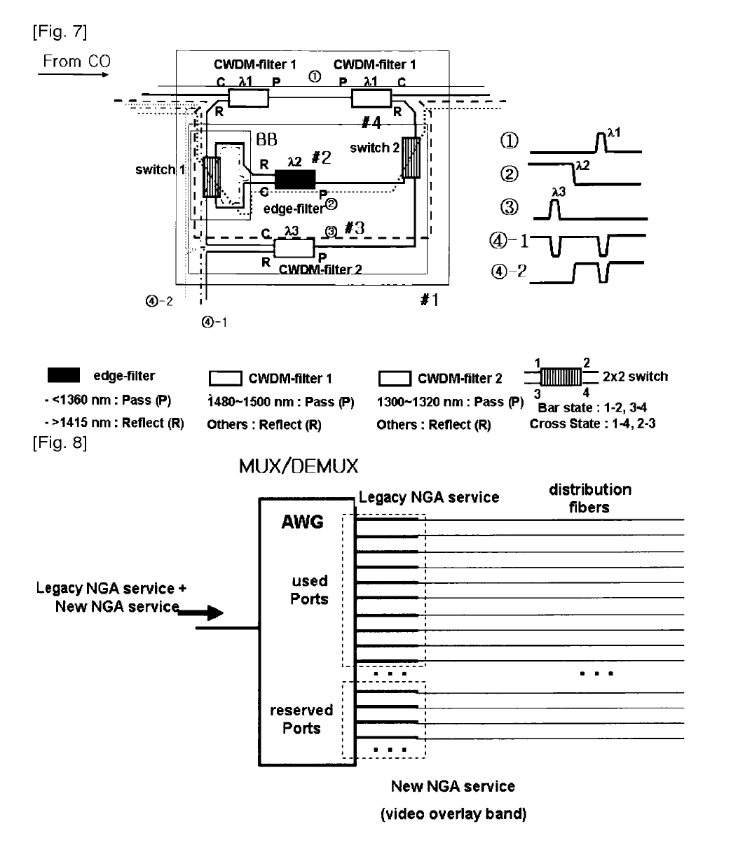

FIGS. 6 and 7 illustrate specific embodiments of a band block for embodying an embodiment of an RN configuration of the present invention illustrated in FIG. 2.

It has been standardized that a band of 1260˜1360 nm is used for an upstream signal, while a band of 1480-1500 nm is used for a downstream signal for signal transmission in a TDM-PON. A legacy TDM-PON and an NGA-PON share one feeder fiber and are co-existing, and it is desirable that the wavelength band being used for the legacy TDM-PON is maintained as it is, while the remaining band is to be newly used as the wavelength band for the NGA-PON, for the purpose of evolution. As a method for embodying the features described above, some methods are being discussed where various service including not only bands for transmitting a TDM-PON service, but also bands for transmitting a WDM-PON and bands for transmitting a video service (mainly a broadcasting service) (hereinafter referred to “a video overlay band”: specifically a band of 1550˜1560 nm), etc. are effectively provided by using given network resources of one subscriber network. Specifically, in order to provide a new service with a different signal band to the subscribers through one feeder fiber, it is desirable to install a WBCS in advance at the RN, which is capable of splitting and combining upstream and downstream signals of the TDM-PON and signals for a new service. However, a method of switching some or all of a band being used for a legacy network and using the switched band is more desirable to solve the problems relating to a required increase of bandwidth, an increase in number of subscribers, and an enhancement of service quality. Methods of switching the video overlay band of 1550˜1560 nm to a new service band which is supposed to be used later for a WDM-PON or an NGA TDM-PON having a higher transmission speed, etc. and using the new service band, or methods of using the video overlay band of 1550˜1560 nm to a new service band or to an IP-based data communications are actively being discussed as an example of the more desirable method. In addition, a method of reusing some of the band of 1260˜1360 nm of the existing TMD-PON (legacy PON: see FIG. 1) as a band for other service is also being discussed. As an example relating to the method of reusing, methods of using a coarse wavelength division multiplexing (CWDM) signal band with a band of 1300˜1320 nm from a service band being used for the TDM-PON, while switching the remaining bands other than 1300˜1320 nm (i.e., a band of 1260˜1300 nm and a band of 1320˜1360 nm) to other service bands and reusing the switched service bands are also being discussed. Moreover, methods of switching whole services of the TDM-PON to whole services of the WDM-PON ultimately, or methods of either increasing the number of subscribers by switching any service bands to other service bands or providing more enhanced services are also being discussed. Hereinafter, specific embodiments of a band block for embodying a switching of those specific bands and reusing the switched bands.

FIG. 6 illustrates a first embodiment of a wavelength band switching for providing new services at the RN of the present invention illustrated in FIG. 2.

Referring to FIG. 6, the RN of the present invention includes a configuration for switching a specific band (λ3) for one service to other service optical path in a transmission system where a TDM-PON service, a WDM-PON service, a video overlay service, etc. are co-existed. Specifically, a first embodiment for a wavelength band switching illustrated in FIG. 6 illustrates an example of stopping a service of the specific wavelength band (λ3) being used and switching the specific wavelength band to other service when necessary.

More specifically, a video overlay band (λ3) is provided to a TDM-PON service path and is used therein, while bands complementary to the video overlay band (λ3) are provided to a WDM- PON service path. A broadcasting video service by the video overlay band (λ3) may be provided for subscribers through a path between a port (A) and a port (B), while the WDM-PON service, which is an NGA service, may be provided through a path between the port (A) and a port (C). When the TDM-PON service and the video overlay service is evolved and upgraded to the WDM-PON service, which is an NGA service, an evolution and an upgrade are made by using a previously allocated WDM-PON band (see FIG. 3). However, such an evolution and an upgrade in a manner described above have a disadvantage in that a wavelength bandwidth being used for other service cannot be reused. That is, it is not able to use some of usable bandwidth for given wavelength band resources. In order to prevent such a disadvantage, it is desirable to use a specific service band such as the video overlay band (λ3) in other service, when the specific service band is not being used. As an effective method for this purpose, an embodiment of a method capable of effectively providing a video overlay band, which is provided together with a TDM-PON service, for a WDM-PON band is illustrated in FIG. 6.

A switching block (BB) illustrated in FIG. 6 performs a band switching upon request for a new service, by switching and control of a split and combined path relating to a specific band. Especially, a configuration and an operation of the RN illustrated in FIG. 6 has a feature in that the RN is operated as a PON at ordinary times, while it is possible to make a required band switching by providing power instantaneously from a remote site (for example, a CO) upon necessity and by switching the switching block (BB). As a method for this purpose, it is desirable that the switch being used at the switching block (BB) is embodied by a latching switch.

According to an embodiment relating to a configuration and an operation of RN illustrated in FIG. 6, in RN where a WBCS (#1) having a port (A), a port (B), and a port (C) is provided, different specific services such as a TDM-PON service being provided through an optical path \textcircled{1} and an optical path \textcircled{2}, a WDM-PON service being transmitted through an optical path \textcircled{4}-1 or an optical path \textcircled{4}-2, and a video overlay service being provided together with the TDM-PON service through an optical path \textcircled{3} are co-existing. A video signal transmitted from the CO is determined to be switched either to a WDM-PON service path \textcircled{4}-1 (in a bar state) or to a TDM-PON service path \textcircled{3} (in a cross state) by the switching block (BB) at the port (C) of the WBCS (#1). If the TDM-PON service path \textcircled{3} is selected, a video overlay band (λ3) transmitted by a first band selection and combination filter (#2) is split from the corresponding optical path. The split video overlay band (λ3) is switched to be connected to the path \textcircled{2} which provides the TDM-PON service through a second band selection and combination filter (#3). In addition, the remaining bands which do not include the split video overlay band (λ3) (when the state of the switching block (BB) is in a cross state) are to progress to the path \textcircled{4}-2 by the first band selection and combination filter (#2). Here, the first band selection and combination filter (#2) and the second band selection and combination filter (#3) are respectively an element having a function of either splitting a signal with the video overlay band (λ3) and a signal with the remaining different bands from one optical fiber or combining the signal with the video overlay band (λ3) and the signal with the remaining different bands to one optical fiber, and the second band selection and combination filter (#3) is connected to a CWDM filter (CWDM filter 1) and a second edge filter (edge filter 2) within the WBCS (#1), respectively.

A selective combination of a video overlay band filter (CWDM filter 2) in a specific optical path using the switching block (BB) has an advantage of reusing the video overlay band (λ3) by removing an influence of the video overlay band filter (CWDM filter 2) when the video overlay band (λ3) including a guard band is used for the WDM-PON service when the video-overlay band (λ3) is not used for broadcasting video service. More specifically, a band selection using a filter (for example, the CWDM filter 2) causes a loss equivalent to a bandwidth corresponding to the guard band due to a finite selection characteristic which is intrinsic in such a filter. However, in the configuration illustrated in FIG. 6, it may be recognized that an influence by the video overlay band filter (CWDM filter 2) as can be seen from a band characteristic of the path \textcircled{4}-1, in case that a TDM-PON service path does not use the video overlay service (i.e., the switching block (BB) is in a bar state). That is, all the whole bands including a guard band, outputted from the port (C) after a band switching is made, may be reused at the WDM-PON service.

An embodiment of a wavelength band switching described in FIG. 6 illustrates a specific band selection and switching through a combination of the first and the second band selection and combination filters (#2 and #3: specifically, the CWDM filter 2) and the switching block (BB). More specifically, it is illustrated that the switching block (BB) is combined to a path of the port (C) of the WBCS (#1), and the second band selection and combination filters (#3) is combined between the CWDM filter (CWDM filter 1) and the second edge filter (edge filter 2) within the WBCS (#1), respectively. However, it is obvious that those positions for selection and combination may be selected at any optical path where a specific service exists and may be combined to any optical path capable of providing such a specific service.

Further, it is obvious that the specific band selected by the switching block (BB) and the first band selection and combination filters (#2) is provide to a separate different service, without being combined with the WBCS (#1). Moreover, although the switching block (BB) illustrated in FIG. 6 is described to be embodied by a specific switching block (BB) having three ports having a specific combination with the band selection and combination filters (specifically, the CWDM filter 1, and the CWDM filter 2 of #2), any skilled person in the art may fully understand that the switching block (BB) may be configured in a various manner by a switching block having three ports or a switching block having four ports, etc. by way of an appropriate combination with a plurality of band selection and combination filters.

FIG. 7 illustrates a second embodiment of a wavelength band switching for providing new services at the RN of the present invention illustrated in FIG. 2.

Referring to FIG. 7, the RN of the present invention is applied to a case of switching some band (λ3) of a specific band (λ2) of one service to a different service in a transmission system where a TDM-PON service and a WDM-PON service, etc. are co-existing, and the some band (λ3) of the specific band (λ2) is switched, while un-switched bands from the specific band (λ2) (λ2 band except λ3) may be used in a new service. More specifically, in the configuration illustrated in FIG. 7, only a band (λ3) of 1300˜1320 nm is allocated from a band (λ2) of 1260˜1360 nm corresponding to the legacy TDM-PON upstream signal, while the remaining bands (λ2 bands except λ3, i.e., a band of 1260˜1300 nm and a band of 1320˜1360 nm) may be used in a new service.

A first switch (switch 1) and a second switch (switch 2) illustrated in FIG. 7 performs a band switching upon request of a new service. Especially, a configuration and an operation of RN illustrated in FIG. 7 has a feature in that the RN is operated as a PON at ordinary times, while it is possible to make a required band switching, etc. by providing power from a remote site (for example, a CO) upon necessity and by performing a control of the switching block (BB). As a method for this purpose, it is desirable that the switches being used are respectively embodied by a latching switch.

According to an embodiment relating to a configuration and an operation of the RN illustrated in FIG. 7, in RN including a WBCS (#1) having three ports, different specific services such as a TDM-PON service being provided either through an optical path \textcircled{1} and an optical path \textcircled{2} or through the optical path \textcircled{1} and an optical path \textcircled{3} and a WDM-PON service being transmitted through an optical path \textcircled{4}-1 or an optical path \textcircled{4}-2 are co-existing. In this configuration of RN, a TDM-PON service path to either the optical path \textcircled{2} or the optical path \textcircled{3} may be configured selectively depending on a state of the second switch (switch 2). Similarly, a WDM-PON service path to either the optical path \textcircled{4}-1 or the optical path \textcircled{4}-2 may be configured selectively depending on a state of the first switch (switch 1). With this, it is possible that some part (λ3) of a specific band (λ2) of one service is provided for a legacy service band, while the remaining bands (λ2 bands except λ3) is used in a different service. More specifically, in embodiment illustrated in FIG. 7, when an upstream bandwidth (100 nm) corresponding to 1260˜1360 nm is limited to the bandwidth (20 nm) of 1300˜1320 nm, it is possible to switch a path to the optical path \textcircled{3} for the limited bandwidth (20 nm) and provide an additional bandwidth (80 nm) to the optical path \textcircled{4}-2 consequently, which is the WDM-PON service path. In order to switch a band, a first band selection and combination filter (#2: specifically, Edge filter) for selecting the corresponding band, a second band selection and combination filter (#3: specifically, CWDM filter 2), a first switch (switch 1), and a second switch (switch 2) may be configured. In case of switching to the optical path \textcircled{2} by the first switch (switch 1) and the second switch (switch 2) (the first switch and the second switch are all in a cross state), the bands capable of being used for the WDM-PON service are indicated as bands corresponding to the optical path \textcircled{4}-1 (see right side legend in FIG. 7). However, in case of switching to the optical path \textcircled{3} (the first switch and the second switch are all in a bar state), the bands capable of being used for the WDM-PON service are indicated as bands corresponding to the optical path \textcircled{4}-2 (see right side legend in FIG. 7).

Although an embodiment of a wavelength band switching described in FIG. 7 illustrates selective combinations of bands corresponding to the first band selection and combination filter (#2: specifically, Edge filter) and the second band selection and combination filter (#3: specifically, CWDM filter 2) by the first switch (switch 1) and the second switch (switch 2), respectively, any skilled person in the art may fully understand that it is possible to combine selectively a n-numbered plurality of bands (n>2) by using a plurality of filters and the switching block (BB). In this case, ×2 switch should be substituted by any 1×n switch.

FIG. 8 illustrates an embodiment relating to a switching configuration of a MUX/DEMUX for connecting a new band resource, which occurs when switching from one service to a different service, to distribution fibers. In this embodiment, methods of configuring an RN which allocates new services, occurring due to a switching of a service having a specific band, to new subscribers and for connecting newly allocated bands and/or the new services to respective subscribers. Hereinafter, such methods will be described in more detail.

FIG. 8 illustrates an embodiment of switching a specific band of a specific service to a different service which occurs when switching from one service to a different service, and will be described for the case of a switching of a video overlay band. That is, it will be illustratively described to provide a new NGA service by adding a newly switched video overlay band (e.g., a λ3 band which is a band available except bands corresponding to the path \textcircled{4}-2 from the path \textcircled{4}-1 illustrated in FIGS. 6 and 7. In this case, the path \textcircled{4}-1 can provide an existing NGA service and the new NGA service corresponding to the newly switched video overlay band (λ3)) to the existing NGA service (e.g., a band corresponding to the path \textcircled{4}-2 illustrated in FIGS. 6 and 7).

FIG. 8 illustrates an embodiment relating to a switching configuration of a MUX/DEMUX depending on a band switching in RN of the present invention illustrated in FIG. 2.

Referring to FIG. 8, in a switching configuration of a MUX/DEMUX according to an embodiment of the present invention, any ports which are not used at an existing MUX/DEMUX can be used for a connection switching of a new NGA service. More specifically, the existing NGA service band is used in a manner of being connected to a plurality of used ports being already used and to a plurality of first distribution fibers corresponding to the plurality of used ports, while a newly occurring band (a video overlay band) is used in a manner of being connected to a plurality of reserved ports of a MUX/DEMUX which does not provide services and to a plurality of distribution fibers which is corresponding to the plurality of reserved ports, depending on a band switching scenario. The MUX/DEMUX illustrated in FIG. 8 may be embodied by an AWG. Like the above, it is described a case where a MUX/DEMUX corresponding to a new service is reserved and the existing MUX/DEMUX for providing a legacy service uses reserved ports of an AWG for this purpose, in order to switch a band for the new service and to provide the switched band for subscribers effectively at the new RN configuration described in FIG. 2.

In order to accomplish a method for reserving the MUX/DEMUX, various methods capable of providing a MUX/DEMUX corresponding to a new service band are existing such as a method of reserving a separate AWG for a newly occurring band and switching to be connected to the distribution fibers, a method of switching a new service to a path to a plurality of distribution fibers, by using a MUX/DEMUX like a 1×N cyclic AWG having a cyclic multiple transmission characteristic in a wavelength band, through a MUX/DEMUX which is the same as the 1×N cyclic AWG, and a method of switching a new NGA service to a path to reserved distribution fibers, by using a MUX/DEMUX like an N×N AWG having a cyclic and periodic characteristic, through a MUX/DEMUX which is the same as the N×N AWG, etc. These examples describe a configuration capable of using a new service band in addition to an existing band characteristic by using a cyclic and periodic characteristic of an existing AWG, and may provide services without incurring additional costs after initial installation and without exchanging a MUX/DEMUX for a required band.

Although an embodiment described above and illustrated in FIG. 8 illustrates a band switching relating to a video overlay band, any skilled person in the art may fully understand that some or all of a specific service in an embodiment of the present invention described above may be switched to another service and a switched service may be switched to configure a new connection to subscribers through reserved ports.

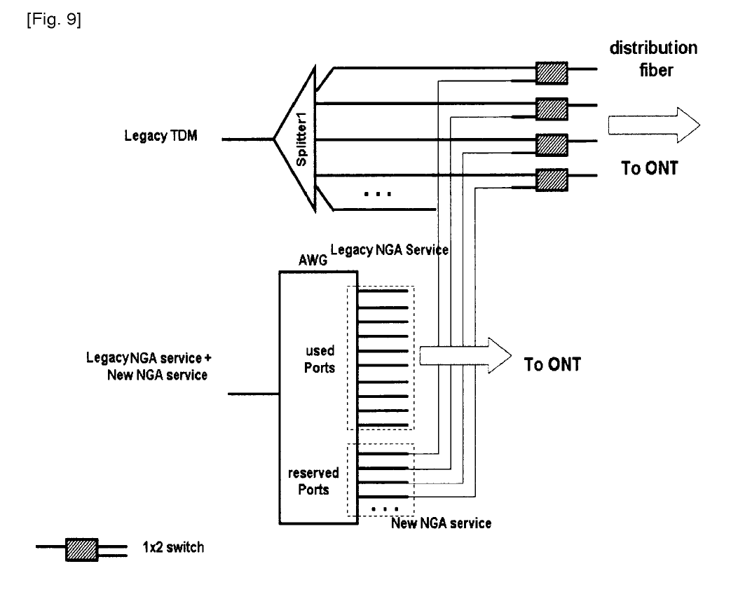

FIG. 9 illustrates another embodiment of a configuration for an optical path switching for providing enhanced services through a new RN.

Specifically, as an embodiment relating to a method of an evolution and an upgrade of a TDM-PON service to a WDM-PON service in a network where a TDM-PON service, video overlay service, and a WDM-PON service are co-existing, it may be explained illustratively when an evolution and an upgrade of the TDM-PON service to the WDM-PON service is made by using reserved bands, or when an evolution and an upgrade is made by using a band, which occurs through a band switching of the TDM-PON service, as the WDM-PON service. The reserved bands may explain illustratively bands except a band being used for the TDM-PON service, which is provided by a WBCS described in FIGS. 4 and 5. The band switching described above explains illustratively a band switching relating to a video overlay band or a specific band switching of a TDM-PON service described in FIG. 6 or 7.

Hereinafter, an optical path switching for providing enhanced services will be explained by using a switched specific band (a video overlay band).

An optical path switching configuration for providing enhanced services according to an embodiment of the present invention is directed to a path switching configuration for connecting a specific optical signal to a specific distribution fiber, and outputs a specific band (a video overlay band), which is switched from a specific service to a different service, through a pre-established MUX/DEMUX (e.g., AWG) and combines a specific band corresponding to the switched specific band with a specific distribution fiber. In this case, an output path of a service to be switched at the AWG is reserved, and connections between a plurality of specific distribution fibers and reserved ports, which provide a new service band (a video overlay band), are made by using a plurality of 1×2 switches.

In addition, in an operation of a band switching according to an embodiment of FIG. 9, it is configured to switch to a required service by power and controls necessary for a band switching from a remote site like a CO only when operating a band switching, while being operated in a passive state without energy at ordinary times. According to an embodiment of the present invention illustrated in FIG. 9, in case of switching a video overlay wavelength band to a WDM-PON service and using the switched video overlay wavelength band, it may be switched to connect the reserved ports of the MUX/DEMUX (e.g., AWG) to the distribution fibers of legacy TDM-PON subscribers by using a plurality of switches (1×2 switches) in order to provide the video overlay wavelength band to the legacy TDM-PON subscribers. That is, since that a legacy video overlay band is switched to a WDM-PON service which is selectively provided for another service, it is possible to provide selectively again a new NGA service (a video overlay band) being provided newly for the subscribers for which the legacy TDM-PON service or the video overlay service is provided.

A method of providing an effective management of power in a method of connecting selectively to a plurality of specific distribution fibers by using the plurality of switches (1×2 switches) may control separate switches sequentially and thus connect required paths sequentially, like in FIG. 3.

Although FIG. 9 described above illustrates a provision of a new service to the legacy subscribers by using a switched specific band, it is obvious that FIG. 9 may be applicable to a case of using reserved bands. Further, although a band switching according to an embodiment of a wavelength band switching illustrated in FIG. 9 described above describes either a band switching of a video overlay band or a switching of a specific band of a TDM-PON service, any skilled person in the art may fully understand that the examples of a wavelength band switching of the present invention described above nay be applicable to all cases capable of switching some or all of specific service to a different service.

FIG. 10 illustrates an embodiment of methods of configuring a connection to a reserved protection fiber when a fault occurs over a specific optical path of working fiber s being operated currently, in the RN configuration and an operation according to the present invention.

An RN configuration according to the present invention illustrated in FIG. 10 is directed to a method of configuring an RN in a manner that a fault of a network may be restored by reconfiguring of an optical path to a different optical fiber (a protection fiber) when a fault occurs over a working fiber. An operation of the RN for a protection and a restoration of a network as described above is characterized in that the RN is operated as a PON maintaining a passive state, at ordinary times and the power is provided through a remote site and is used for reconfiguring a path to a protection fiber.

Specifically, in an RN configuration and an operation thereof capable of providing a protection and restoration function of a network according to an embodiment illustrated in FIG. 10, if a fault occurs over a working fiber, then communications through a corresponding path becomes a disabled. Hereinafter, a method of restoring a fault relating to a feeder fiber and a method of restoring a fault relating to a distribution fiber will be described as specific examples.

First, when a fault occurs over a feeder fiber (feeder fiber 1) being operated currently, a detection of the fault and a switching of a path to a reserved feeder fiber (feeder fiber 2) are made. In this case, it is possible that a path switching at the CO can be made by reconfiguring a path using existing reported methods of switching an optical path (switches and a WBCS, etc.) because electric power at the CO is available at ordinary times. On the other hand, a constant powering is not available in a PON so that a new method of reconfiguring an optical path is required. For this purpose, it is possible to reconfigure an optical path where a fault occurs over a reserved optical path by employing a method of reconfiguring an RN where the power being provided through an optical fiber from a remote site can be used for the RN, while being operated as a PON maintaining the RN in a passive state at ordinary times. In this case, the power is provided to a control agent through a WBCS3 (λ3) being connected to a feeder fiber (feeder fiber 2 or a reserved protection fiber) and a power generation block, and a switching of an optical path to the protection fiber may be made.

Although it is not illustrated in FIG. 10, a switch, etc. capable of switching a path between a working fiber (a feeder fiber 1) and a reserved protection fiber may be existing at CO or ONT, like a switching at RN, and a path switching may be available when respective working fibers become failed. Generally, an operation of power may be made easily at CO or ONT so that a fault may be detected by a monitoring system of network and switches of relevant optical paths are activated. An optical path is switched at CO and ONT like these methods, and switches for protection and restoration corresponding to the paths where a fault occurs from a plurality of switches (switch#0 -switch#n) for protection and restoration at the RN are operated by providing energy necessary for an operation of the RN as optical energy from a remote site like the CO through an optical fiber and by converting the optical energy to electric energy in order to switch an optical path of the RN. That is, because an optical path may be switched through a control from a remote site, a protection and restoration function capable of providing enhanced services may be provided even at a PON.

More specifically, referring to FIG. 10, if a fault occurs over a working fiber (feeder fiber 1), an optical path through CO is switched to be connected to a reserved fiber (feeder fiber 2 or a protection fiber). When an optical powering signal for an operation of the RN is transmitted from a remote site like a CO, the optical powering signal is extracted through a WBCS3 (λ3). The extracted optical powering signal is transmitted to the power generation block so that the power generation block converts optical power into electric power, and the generated electric power activates ×2 switch (#0) so as to change the path of the RN. Similarly, if a fault occurs over any working fiber of the distribution fibers, an optical path to ONT is switched to a reserved protection fiber. Likewise, when an optical powering signal for the operation of the RN provided from a remote site like a CO is transmitted, the optical powering signal is extracted through the WBCS3 (λ3). The extracted optical powering signal is transmitted to the power generation block so that the power generation block converts optical power into electric power. The control agent block using the generated electric power activates relevant switches corresponding to ×2 switches (#1-#n) so as to change the path at the RN. Although an embodiment illustrated in FIG. 10 describes only a protection and restoration function of a network, such an embodiment may be embodied along with the methods of operation RN (e.g., a band switching, etc.) as previously described.

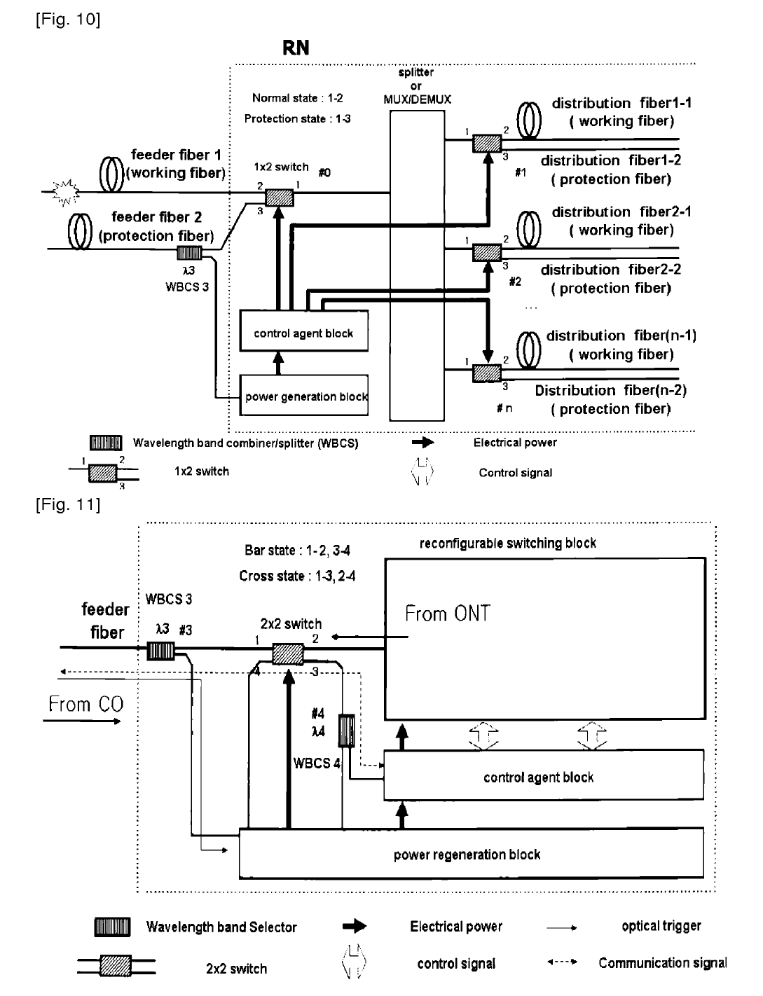

FIG. 11 illustrates an embodiment of a configuration of a power generation block at a new RN of the present invention.

Referring to FIG. 11, a configuration of a power generation block for regenerating power required at a new RN according to an embodiment of the present invention uses a low power laser rather than a separate optical powering signal having high power as a trigger signal to obtain the power required for activating the RN. More specifically, optical power, which is used for communication within a network, being outputted from OLTs at the CO or optical power being outputted from ONTs is switched to be used for power for operation of the RN instantaneously. When an optical trigger signal is transmitted from a remote site like a CO or ONTs as a signal for configuring the RN according to an embodiment illustrated in FIG. 11, the optical trigger signal is extracted through a third WBCS (#3). The extracted optical signal (λ3) is transmitted to the power generation block and is converted into electric energy. When the converted electric energy (electric power) activates 2×2 switch and switches it from a bar state to a cross state, the RN stops the communication, while optical signals are provided to the power generation block. In this case, a fourth WBCS (#4) may select some optical signal (λ4) for communication with CO or the remote site, which may be used for a communication channel. The optical signal transmitted from OLTs at the CO and the optical signal transmitted from ONTs, except the optical signal (λ4) being used for the communication channel, are switched to an input to the power generation block by the fourth WBCS (#4), and the power generation block generates enough electric power required for an operation of the RN. In this way, it is possible to regenerate electric power for the operation of the RN by using only optical power of an optical trigger signal with low-cost and low power, without using another high power laser source, in the present invention. As described above, some optical signal (λ4), which, depending on a power management scenario, is extracted by the fourth WBCS (#4) and then may be used for a communication channel between the control agent block and OLT within CO or subscribers (or ONT at the subscriber end). That is, it is possible to use some optical signal band for a control of an RN and a communication thereof, etc., instantaneously rather than continuously from a band to be switched for the generation of power, without providing a separate reserved communication channel. When stopping a provision of the optical trigger signal, the RN returns to it original communication state, and accordingly is operated under an environment of the RN which is newly configured. As s more specific example, when using a non-latching 2×2 switch as the 2×2 switch described above, it is possible to configure in a manner that the non-latching 2×2 switch is switched to a cross state when providing energy by the trigger signal, while the non-latching ×2 switch returns to a bar state, which is its original path state, when removing energy by the trigger signal.

The switches (including the switches within the switching block) to be used effectively in a configuration of the embodiments illustrated in FIGS. 2 to 10 described above is desirable to be embodied by a latching switch as described above. That is, in an embodiment of the present invention, power is provided only at the moment of a RN reconfiguration, and thereafter latching switches may be used for maintaining the elements of the RN in a passive state. Commercial products with various types including micro electro mechanical systems (MEMS) type may be used, as those latching switches, for performing a low-electric power operation and a stable operation. In addition, the configurations of the embodiments of the present invention illustrated in FIGS. 2 to 10 described above may control the switching of an RN effectively by using an optical signal itself without regenerating or converting optical power to an electric power. That is, when using all-optical latching switch at the RN configuration, an optical signal itself having a specific wavelength controls an optical path and a switched state of the all-optical latching switch can be maintained without optical power.

Further, the control agent block which may be used effectively in the embodiments of the present invention illustrated in FIGS. 2 to 11 described above is desirable to have network management system (NMS) functions. The NMS functions refer to any works relating to all network managements, such as a function of maintaining an RN in a passive state at ordinary times, a function of reconfiguring the RN when being provided by power from a remote site, a function of recording reconfiguration results in the RN, and a function of reporting the recorded reconfiguration results upon a request from a network manager, etc. The control agent block having this NMS function may sustain information of a previous switched state and information relating to the network even when no power is provided, and sustain information upon configuring a new network and confirm a test and a request when such a test and a request for a network state and characteristic are reported through a communication with a remote site depending on a necessity. Some or all of the NMS functions can be used as a part of a configuration of the control agent block.

Moreover, various supplementary powering devices may be included in the embodiments of the present invention illustrated in FIGS. 2 to 11 described above, in order to configure an RN effectively. Although it is possible to provide power from a remote site, an environment necessary for providing power to the RN in situ or near a specific RN may occur depending on circumstances. Specifically, other supplementary electric powering device may be used, in addition to a case that optical powering is being provided through an optical fiber as described above. More specifically, when making a parallel connection of separate ports of the supplementary powering device to ports of an optical powering device being a part configuring the RN, it is possible to activate the RN in other method rather than to operate an RN by optical powering. That is, it is possible to use electric power which is provided according to a more advantageous method, by using an available power by providing a supplementary method in order to cope with an operational environment of a network (specifically, a network that the power can be provided at ordinary times through an easy way rather than a provision of optical powering) smoothly. As a separate electric powering device, a wireless powering device capable of transmitting an RF, a microwave, or light, etc., on a free space, a wired powering device which provides electric power though wires near the RN, an energy-convertible powering device capable of converting, for example, thermal energy to energy such as electricity or light, etc., and an supplementary powering device capable of providing energy by using a power storage element, like a battery, at the RN and by charging the electric power storage element when necessary, etc. may be used. Those separate powering devices may activate the RN by providing power instantaneously while maintaining the RN in a passive state except only when a necessity occurs.

Moreover, the embodiments of the present invention illustrated in FIGS. 2 to 11 described above may include various supplementary communication devices which are necessary for configuring an RN effectively and are for a communication with the outside. Although it is possible to control information relating to an RN by a communication through a control from a remote site, a method of controlling such information in situ or near a specific RN may be required depending on circumstances. More specifically, a communication with the RN in other manner rather than a communication with the RN by an optical communication becomes possible by adding separate supplementary communication devices to the communication devices described above. That is, it makes possible to use an supplementary communication channel so as to cope with smoothly depending on an environment of operating a network (for example, in case that configuring an RN in situ and operation information are required or in case of identifying information relating to an RN in a more effective method rather than a method of using an optical communication, etc.). In this case, as a supplementary communication device used in an RN, various supplementary communication devices such as a wireless optical communication device using light or an infrared ray which may be transmitted in a free space, a wire optical communication device using an optical fiber, etc., and, an electric wireless communication device using a microwave or an RF band, etc. may be used. Those supplementary communication devices may perform a control and a communication relating to an RN through an instantaneous operation of electric power in the RN being operated in a passive state only when a necessity occurs.

Although all the embodiments of the present invention described above describe a case of switching a video overlay signal band or some bands of a TDM-PON service to a WDM-PON service, it is obvious that those embodiments may be applicable in the same way to a case of switching some or all bands of a WDM-PON service to a TDM-PON service or a video overlay signal band. Further, it is also obvious that those embodiments may be applicable similarly to a case of switching between various services described illustratively in those embodiments of the present invention described above and new service with different types.

In addition, the power generation block described in the embodiments of the present invention described above includes a photoelectric converting device. Such a photoelectric converting device is a typical device for converting optical energy to electric energy, and may be comprised of an optical input port for receiving optical energy, electric output ports with two ports (i.e., (+) port and (−) port) or more for outputting converted electric energy, and a converter for converting optical energy to electric energy therein. A converter may refer to an element or a configuration for transforming a physical quantity with one energy state to a physical quantity with another energy state. An element using a photovoltaic effect may be referred to as a typical example of such a photoelectric converting device. It is configured that electric energy generated by a photoelectric converting device is to be provided to an RN configuration of the present invention. As illustrated in FIGS. 2 to 11, power generated from the power generation block may be provided to any block which requires energy. That is, power generated from the power generation block may be provided to the control agent block, and the reconfigurable switching block, etc. and may be used for an operation and a reconfiguration of the RN. As one example, electrical power generated from the power generation block activates the control agent block, and the control agent block provides various switching elements configured for switching an optical path with a control signal and activates the various switching elements. Further, the control agent block may provide a control signal to a band switch of the band block necessary for a band switching and a corresponding switch of the port block for connecting output ports required to be switched to distribution ports by using power generated from the power generation block, and may configure an optical path of a specific service. In addition to the above, power generated from the power generation block may be provided to additional devices for the operation of other additional functions such as communications etc.

Although a new RN configuration described above according to the present invention is described illustratively to be applied to a PON, any skilled person in the art may fully understand that a new RN configuration according to the present invention may be applicable in the same way to an active optical network (AON).

As various modifications could be made in the constructions and method herein described and illustrated without departing from the scope of the present invention, it is intended that all matters contained in the foregoing description or shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

What is claimed is:

1. A remote node (RN) configuration for providing a new service in a passive optical network (PON), comprising
a remote node (RN); and
a remote powering site;
wherein the RN is adapted to operate at ordinary times in a no-power passive state in which power is not supplied from the remote site, and the RN includes a power generation block capable of providing energy necessary for operation of the RN by being provided with energy instantaneously from the remote site;
wherein the RN further includes:
either one or both of a control agent block capable of controlling an optical path of the RN by using power generated from the power generation block and a reconfigurable switching block capable of configuring and switching the optical path of the RN through the power being provided from the power generation block and a control by the control agent block;
a third wavelength band combiner/splitter for splitting a communication signal band being provided through an optical fiber from the remote site and an optical powering signal for generating power, which is not used in the communication signal band, being provided selectively; and
a fourth wavelength band combiner/splitter, being connected to the third wavelength band combiner/splitter, for splitting the communication signal band and the optical powering signal for generating power,
wherein the power generation block is connected to the third wavelength band combiner/splitter and generates electric power necessary for activating the RN from the optical powering signal for generating power extracted by the third wavelength band combiner/splitter;
wherein the control agent block controls a reconfiguration of the optical path of the RN and a communication between the RN and the remote site by using the power generated by the power generation block, and
wherein the reconfigurable switching block is connected to the fourth wavelength band combiner/splitter and reconfigure the optical path of the RN by using the power being provide from the power generation block and a control signal being provided from the control agent block.

2. The RN configuration of claim 1, wherein the power generation block includes a photoelectric converter for converting the optical powering signal for generating power extracted by the third wavelength band combiner/splitter to electric energy.

3. The RN configuration of claim 1, wherein the reconfigurable switching block comprises a band block, a MUX/DEMUX block, a port block or a combination thereof.

4. A remote node (RN) configuration for providing a new service in a passive optical network (PON), comprising
a remote node (RN);
wherein the RN comprises a reconfigurable switching block having a band block for switching a specific band of one service to a specific band of another service, and
wherein the band block comprises:
a wavelength band combiner/splitter (#1), being embodied by a first edge filter, a second edge filter being connected to the first edge filter, and one CWDM filter being connected to the first edge filter, for providing a legacy service;
a service selector/splitter comprising a switching block (BB) being connected to the one CWDM filter, and a first band selection and combination filter (#2), being connected to the switching block (BB), for selecting and splitting a specific band (λ3) from the legacy service; and
a second band selection and combination filter (#3), being connected respectively to the first band selection and combination filter (#2), the one CWDM filter, and the second edge filter, for connecting the specific band (λ3) split by the first band selection and combination filter (#2) to the second edge filter.

5. The RN configuration of claim 4, wherein the switching block (BB) is switched not to be connected to the first band selection and combination filter (#2), when the switching block (BB) is in a bar state, and wherein the switching block (BB) is switched to be connected to the first band selection and combination filter (#2), when the switching block (BB) is in a cross state.

6. A remote node (RN) configuration for providing a new service in a passive optical network (PON), comprising
a remote node (RN);
wherein the RN comprises a reconfigurable switching block having a band block for switching a specific band of one service to a specific band of another service, wherein the band block is embodied by a wavelength band combiner/splitter (#1), and
wherein the wavelength band combiner/splitter (#1) comprises:
a first CWDM filter for providing a legacy service and a second CWDM being connected to the first CWDM filter;
a service selector/splitter comprising a first switch being connected to the first CWDM filter, and a first band selection and combination filter (#2), being connected to the first switch, for selecting and splitting a specific band (λ2) from the legacy service;
a second band selection and combination filter (#3), being connected to the first switch, for selecting and splitting some band (λ3) from the specific band (λ2); and
a second switch, being connected respectively to the first band selection and combination filter (#2), the second band selection and combination filter (#3), and the second CWDM filter, for connecting either the specific band (λ2) split by the first band selection and combination filter (#2) or the some band (λ3) split by the second band selection and combination filter (#3) selectively to the second CWDM filter.

7. The RN configuration of claim 6, wherein the first switch is embodied by a switching block (BB), and wherein the second switch is embodied by a 1×2 switch.

8. The RN configuration of claim 7, wherein the switching block (BB) is switched not to be connected to the first band selection and combination filter (#2), when the switching block (BB) is in a bar state, and wherein the switching block (BB) is switched to be connected to the first band selection and combination filter (#2), when the switching block (BB) is in a cross state.

9. A remote node (RN) configuration for providing a new service in a passive optical network (PON), comprising:
a remote node (RN);
wherein the RN includes:
an optical splitter (splitter 1) having a plurality of first output ports for transmitting a first legacy service to a plurality of first group distribution fibers;
a MUX/DEMUX having a plurality of second output ports for outputting a second legacy service, which is not superimposed with the first legacy service, to a plurality of second group distribution fibers, and a plurality of third reserved ports for outputting a specific band, which is split from either one of the first legacy service or the second legacy service, to the plurality of first group distribution fibers; and
a plurality of switches, being placed between the plurality of first output ports and the plurality of first group distribution fibers and being connected to the plurality of third reserved ports, for configuring the specific band to be connected to the plurality of first group distribution fibers, and
wherein the first legacy service and the specific band are being provided selectively to the plurality of first group distribution fibers by the plurality of switches.

10. A remote node (RN) configuration for providing a new service in a passive optical network (PON), comprising
a remote node (RN); and
a remote site;
wherein, when a fault occurs over an optical path which is being operated, the RN is capable of reconfiguring the optical path where the fault occurs to be connected to a reserved optical path by instantaneous powering from a the remote site.

11. The RN configuration of claim 10, wherein the RN further comprises:
a first feeder fiber (feeder fiber 1) being connected to the RN;
a reserved second feeder fiber (feeder fiber 2);
a wavelength band selector (λ3) being connected to the reserved second feeder fiber;
a switch (#0) being connected respectively to the first feeder fiber and the wavelength band selector (λ3);
a MUX/DEMUX being connected to the switch (#0);
a plurality of first to n-th distribution fibers being connected to the MUX/DEMUX;
a plurality of first to n-th switches (#1 to #n) for connecting the MUX/DEMUX and the plurality of first to n-th distribution fibers, respectively;
a plurality of first to n-th protection fibers being connected respectively to the plurality of first to n-th switches (#1 to #n);
a power generation block for providing energy necessary for activating the RN by instantaneous optical powering through the reserved second feeder fiber from the remote site; and
a control agent block for reconfiguring the optical path of the RN by using power generated by the power generation block, and
wherein, when a fault occurs either over the first feeder fiber or over any one of the plurality of first to n-th distribution fibers, the control agent block operates selectively either the switch (#0) or the any one switch of the plurality of first to n-th switches (#1 to #n) corresponding to any distribution fiber of the plurality of first to n-th distribution fibers where the fault occurs, and reconfigures the optical path either be connected to the reserved second feeder fiber or to the distribution fiber of the plurality of first to n-th distribution fibers where the fault occurs.

12. A remote node (RN) configuration for providing a new service in a passive optical network (PON), comprising:
a remote node (RN);
wherein the RN comprises:
a third wavelength band combiner/splitter for splitting a communication signal band being provided through an optical fiber from a remote site and an optical trigger signal, which is not used in the communication signal band and is provided selectively;
a power generation block, being connected to the third wavelength band combiner/splitter, for generating first power from the optical trigger signal extracted by the third wavelength band combiner/splitter;
a switch, being connected to the third wavelength band combiner/splitter and the power generation block, respectively, for switching from a bar state to a cross state or vice versa by being provided with the first power generated from the power generation block;
a control agent block, being connected to the switch, for controlling a reconfiguration of an optical path of the RN and a communication between the RN and the remote site by using some signal band of the communication signal band transmitted through the third wavelength band combiner/splitter when the switch is in the cross state;
a fourth wavelength band combiner/splitter, being provided between the switch and the control agent block, for splitting the some signal band of the communication signal band transmitted through the third wavelength band combiner/splitter when the switch is in the cross state and connecting the split some signal band to the control agent block, and for connecting signals other than the split some signal band among the communication signal band to the power generation block so as to generate second electric power necessary for activating the RN; and
a reconfigurable switching block, being connected to the switch, for reconfiguring the optical path of the RN by using the second power being provided from the power generation block and a control signal being provided from the control agent block when the switch is in the bar state.

13. A passive optical network (PON) comprising:
a central office (CO);
a remote node (RN) connected to the CO through an optical fiber; and
a plurality of ONTs connected to the RN by distribution fibers,
wherein the RN comprises:
a third wavelength band combiner/splitter for transmitting a communication signal band being provided from the CO or the plurality of ONTs and an optical powering signal for generating power, which is not used in the communication signal band and is provided selectively;
a fourth wavelength band combiner/splitter, being connected to the third wavelength band combiner/splitter, for splitting the communication signal band and the optical powering signal for generating power;
a power generation block, being connected to the fourth wavelength band combiner/splitter, for generating power necessary for activating the RN from the optical powering signal for generating power extracted by the third wavelength band combiner/splitter;
a control agent block, being connected to the fourth wavelength band combiner/splitter, for controlling a reconfiguration of an optical path of the RN and a communication between the RN and the CO or between the plurality of ONTs by using the power generated by the power generation block; and
a reconfigurable switching block, being connected to the third wavelength band combiner/splitter, for reconfiguring the optical path of the RN by using the power being provided from the power generation block and a control signal being provided from the control agent block.

14. An active optical network (AON) comprising:
a central office (CO);
a remote node (RN) connected to the CO through an optical fiber; and
a plurality of ONTs connected to the RN by distribution fibers,
wherein the RN comprises:
a third wavelength band combiner/splitter for transmitting a communication signal band being provided from the CO or the plurality of ONTs and an optical powering signal for generating power, which is not used in the communication signal band and is provided selectively;
a fourth wavelength band combiner/splitter, being connected to the third wavelength band combiner/splitter, for splitting the communication signal band and the optical powering signal for generating power;
a power generation block, being connected to the third wavelength band combiner/splitter, for generating power necessary for activating the RN from the optical powering signal for generating power extracted by the third wavelength band combiner/splitter;
a control agent block, being connected to the fourth wavelength band combiner/splitter, for controlling a reconfiguration of an optical path of the RN and a communication between the RN and the CO or between the plurality of ONTs by using the power generated by the power generation block; and
a reconfigurable switching block, being connected to the third wavelength band combiner/splitter, for reconfiguring the optical path of the RN by using the power being provided from the power generation block and a control signal being provided from the control agent block.
